(19) United States
(12) Patent Application Publication
(10) Pub. No.: US 2016/0228808 A1
(43) Pub. Date: Aug. 11, 2016

(54) APPARATUS FOR DESTRUCTION OF AIRBORNE CONTAMINANTS

(71) Applicant: Reginald Wayne CLARK, San Diego, CA (US)

(72) Inventor: Reginald Wayne Clark, San Diego, CA (US)

(21) Appl. No.: 15/022,899

(22) PCT Filed: Sep. 17, 2014
(86) PCT No.: PCT/US14/56140

§ 371 Date: Mar. 17, 2016

Related U.S. Application Data
(60) Provisional application No. 61/880,021, filed on Sep. 19, 2013.

(51) Int. Cl. B01D 53/00; B01D 53/66

(52) U.S. Cl. CPC B01D 53/007; B01D 53/66; B01D 2259/804

(57) ABSTRACT

The present disclosure relates to a reflective cavity technique that significantly increases the intensity and uniformity of UV energy, enabling very high and uniform UV irradiance. The high UV irradiance and high uniformity are coupled with techniques for increasing the residence time in the reflective cavity to achieve UV doses and airflow uniformity that are sufficient to allow high efficiency destruction of airborne contaminants such as ozone.

### CROSS REFERENCE TO RELATED APPLICATIONS

This application claims priority to U.S. Provisional Application No. 61/880,012, filed Sep. 19, 2013, the disclosure of which is hereby incorporated by reference.

### BACKGROUND

Embodiments discussed herein relate generally to the use of ultraviolet energy to destroy contaminants in flowing air. More specifically, such embodiments relate to apparatus and methods of using high intensity ultraviolet light to effectively destroy contaminants using a reflective cavity technique that significantly increases the intensity and uniformity of UV energy, enabling very high and uniform UV irradiance and techniques for extending the exposure time of flowing air to increase accumulated UV dose.

Ultraviolet (UV) energy can be used to destroy certain airborne chemical contaminants. The destruction process occurs when photons of an appropriate wavelength are absorbed by a chemical molecule causing molecular bonds to be broken and reducing the chemical contaminant to component molecules or atoms. A particular application of interest is the destruction of ozone in airstreams.

Ozone (O₃) is a form of oxygen that consists of three oxygen atoms joined together into a molecule. This form of oxygen has significantly different characteristics than the common oxygen molecule (O₂), which consists of two oxygen atoms. The ordinary O₂ form of oxygen is, of course, present in the air we breathe and is indeed necessary for life.

The role of ozone in the environment is more complicated. First, ozone in the upper atmosphere plays an important role in protecting life on earth by absorbing dangerous short wavelength UV from the sun. However, it is harmful in the lower atmosphere since it is an irritant when breathed and is therefore an undesirable air pollution component.

Many important industrial processes use or generate ozone. In order to maintain suitable air quality, the ozone content in air emitted from such industrial processes must be reduced to an acceptable concentration level before the air can be safely released into the environment. Ultraviolet energy at the proper wavelength interacts with ozone to disassociate it into ordinary oxygen (O₂) and atomic oxygen.

Very high, uniform UV doses are required in large volumes of air to accomplish significant ozone reduction in industrial air streams. Such UV performance is not practical using conventional UV technology. If sufficiently high doses of UV at the proper wavelength are applied, ozone can be broken down into molecular and atomic oxygen. Low UV doses and lack of uniformity of the UV radiation can, however, significantly reduce the effectiveness of UV for destruction of chemical contaminants. The reflective cavity technology described herein allows the creation of uniform UV irradiances that are 5 to 50 times those that would be available from a conventional UV system.

In addition to high UV flux, substantial treatment times are required to achieve the high UV doses required for destruction of contaminants such as ozone. Treatment time for flowing air streams can be increased by increasing the dimension of the air treatment system in the direction of the air flow, by decreasing the flow velocity, or by a combination of these methods. Increasing the length of the system has practical limitations in many industrial applications where available space is limited and can also significantly increase the cost of the system.

Long residence times needed to increase UV dose can lead to flow disturbances due to heating of the air. These thermal effects can have a strong negative effect on the contaminant destruction process. When low flow velocities are used to extend the residence of air in the cavity, correction of the flow disturbances are difficult to achieve with many flow control structures such as vanes and chevrons because of the low kinetic energy of the air stream.

The embodiments described herein provide a means for creating a major improvement in capability to destroy airborne contaminants such as ozone in industrial air streams by applying UV flux multiplication in a UV cavity to increase the intensity and uniformity of the UV flux and incorporating devices within the cavity to address thermal issues related to extending the treatment time.

### SUMMARY

The systems, methods and devices discussed herein each have several innovative aspects, no single one of which is solely responsible for the desirable attributes disclosed herein.

In one embodiment, an ultraviolet (UV) treatment apparatus is provided, including a chamber, the chamber including a first input aperture and a first output aperture, where the interior surfaces of the chamber are substantially covered by a diffuse reflective material that is greater than 95% reflective to UV light, at least one UV light source disposed within the chamber, a first input perforated plate extending across the first input aperture of the chamber, a first output perforated plate extending across the first output aperture of the chamber, and at least one internal perforated plate extending across the interior of the chamber, where the at least one internal perforated plate is configured to increase airflow uniformity through the chamber.

The apparatus can additionally include at least one additional internal perforated plate extending across the interior of the chamber and spaced apart from the first internal perforated plate. Each of the first input perforated plate, the first output perforated plate, and the at least one internal perforated plate can extend generally parallel to one another, or at least one of the first input perforated plate, the first output perforated plate, and the at least one internal perforated plate can be oriented at an angle to another perforated plate The first input perforated plate, the first output perforated plate, and the at least one internal perforated plate can be generally planar, or at least one of them may be non-planar.

The internal perforated plate can extend across only a portion of the interior of the chamber, and a seal can extend around the periphery of the internal perforated plate.

At least one of the first input perforated plate, the first output perforated plate, and the at least one internal perforated plate can have a non-uniform distribution of perforation across its surface. The non-uniform distribution of perforation can include a variance in any or all of the number, size, and shape of perforations across the surface of the perforated plate. The non-uniform distribution of perforation can increase airflow uniformity within the chamber.

The apparatus can additionally include a second chamber arranged in series with the first chamber, the second chamber including a second input aperture and a second output aperture, where the interior surfaces of the chamber are substantially covered by a diffuse reflective material that is greater than 95% reflective to UV light, at least one UV light source disposed within the second chamber, a second input perforated plate extending across the second input aperture of the chamber, a second output perforated plate extending across the second output aperture of the chamber, and at least one internal perforated plate extending across the interior of the second chamber, where the at least one internal perforated plate is configured to increase airflow uniformity through the second chamber. The apparatus can additionally include an intermediate duct connecting the first chamber and the second chamber, where the intermediate duct extends between the first output aperture of the first chamber and the second input aperture of the second chamber, and at least one intermediate perforated plate extending across the interior of the second chamber, where the at least one intermediate perforated plate is configured to increase airflow uniformity through the intermediate duct. The apparatus can additionally include an inlet plenum disposed adjacent the first input aperture of the first chamber, and at least one inlet perforated plate extending across the interior of the inlet plenum, wherein the at least one inlet perforated plate is configured to increase airflow uniformity through the inlet plenum. At least three inlet perforated plates can extend across the interior of the inlet plenum. At least two internal perforated plates can extend across the interior of the first chamber. At least two intermediate perforated plates can extend across the interior of the intermediate duct. At least two internal perforated plates extend across the interior of the second chamber.

The perforated plates can be less than 10% open, and can be less than 5% open. A ratio of the sum of the open area and interior surface area uncovered by the diffuse reflective material to the total surface area of the interior of the chamber walls can be less than 0.05, and can be less than 0.01.

In one embodiment, an ultraviolet (UV) treatment apparatus is provided, including a chamber, the chamber including a first input aperture and a first output aperture, where the interior surfaces of the chamber are substantially covered by a diffuse reflective material that is greater than 95% reflective to UV light, at least one UV light source disposed within the chamber, a first input perforated plate extending across the first input aperture of the chamber, a first output perforated plate extending across the first output aperture of the chamber, and means for normalizing the rate of airflow within the chamber. The normalizing means can include a perforated plate disposed within the interior of the chamber.

In one embodiment, a method of reducing the presence of a contaminant in air is provided, the method including exposing the interior of a chamber to ultraviolet (UV) light, the chamber including an input aperture, an output aperture, at least one internal perforated plate disposed between the input aperture and the output aperture, and interior surfaces which are substantially covered by a diffuse reflective material that is greater than 95% reflective to UV light, and directing air through the chamber while the chamber is being exposed to UV light, where exposure of the air to UV light during the passage through the chamber reduces the presence of a contaminant in the air.

Passing through the at least one internal perforated plate can increase the uniformity of the airflow of air directed through the chamber. The amount of perforation of the at least one internal perforated plate can vary across the at least one internal perforated plate.

In one embodiment, an air treatment system is provided, including a chamber, the chamber including a plurality of input apertures and a plurality of output apertures, where the interior surfaces of the chamber are substantially covered by a diffuse reflective material that is greater than 95% reflective to ultraviolet (UV) light, and at least one continuous, narrow-band UV light source disposed within the chamber, where the light source is configured to emit approximately 90% of its UV output energy at wavelengths between 240 nm and 280 nm. In one aspect, the at least one continuous, narrow-band UV light source can include a low-pressure mercury discharge lamp.

In one aspect, a ratio of the sum of the open area and interior surface area uncovered by the diffuse reflective material to the total surface area of the interior of the chamber walls can be less than 0.05. In a further aspect, the ratio of the sum of the open area and interior surface area uncovered by the diffuse reflective material to the total surface area of the interior of the chamber walls can be less than 0.01.

In one aspect, the chamber can include an input end plate including the plurality of input apertures and an output end plate including the plurality of output apertures, where a ratio of open area to the total area of each of the end plates is less than 0.4. In a further aspect, the ratio of open area to the total area of each of the end plates can be less than 0.1.

In one aspect, the air treatment system can be configured to provide an irradiance of at least 75,000 μW/cm2 at any location within the chamber. In one aspect, the air treatment system can be configured to provide an irradiance of at least 100,000 μW/cm2 at any location within the chamber. In one aspect, the air treatment system can be configured to provide an irradiance of at least 150,000 μW/cm2 at any location within the chamber.

In one aspect, the air treatment system can be configured to provide a UV dose of at least 150,000 μW-s/cm2 to air flowing through the chamber.

In another embodiment, an air treatment system is provided, including a chamber, the chamber including a plurality of input apertures and a plurality of output apertures, where the interior surfaces of the chamber are substantially covered by a diffuse reflective material that is greater than 95% reflective to ultraviolet (UV) light, and at least one continuous UV light source disposed within the chamber, where the air treatment system is configured to increase the irradiance at any location within the chamber to at least 10 times the irradiance of the at least one UV light source.

In one aspect, the air treatment system can be configured to provide an irradiance of at least 75,000 μW/cm2 at any location within the chamber. In one aspect, the at least one UV light source can include a narrow-band UV light source.

In another embodiment, an air treatment system for reducing an amount of a contaminant in air passing through the treatment system is provided, the system including a chamber, the chamber including a plurality of input apertures and a plurality of output apertures to allow passage of air containing a contaminant therethrough, where the amount of contaminant in the air can be reduced by exposure to ultraviolet (UV) light, and where the interior surfaces of the chamber are substantially covered by a diffuse reflective material that is greater than 95% reflective to UV light, and at least one UV light source disposed within the chamber, where the air treatment system is configured to increase the irradiance at any location within the chamber by a factor of at least 10.

In one aspect, the contaminant can include ozone. In one aspect, introducing UV light into the chamber can include exposing the air to an irradiance of at least 75,000 μW/cm2 at any location within the chamber.

In one aspect, the at least one UV light source can include a narrow-band UV light source. In one aspect, mechanical securements for the lamps and electrical connections to the lamps are shielded from the UV irradiance to reduce absorption of UV energy in the cavity and enable multiplication of irradiance within the cavity. In one aspect, the air treatment system can be configured to provide an irradiance of at least 75,000 μW/cm2 at any location within the chamber. In one aspect, the air treatment system can be configured to reduce the amount of ozone in air passing through the chamber.

In another embodiment, a method of reducing the presence of a contaminant in air is provided, the method including directing air containing a contaminant into a chamber, where the amount of the contaminant can be reduced by exposure to ultraviolet (UV) light, the chamber having interior surfaces which are substantially covered by a diffuse reflective material that is greater than 95% reflective to UV light, and introducing UV light into the chamber during passage of the air containing the contaminant therethrough, where the UV light is reflected multiple times by the interior surfaces of the chamber to provide an irradiance of at least 75,000 μW/cm2 at any location within the chamber.

In one aspect, a high dose required for destruction of an airborne contaminate can be achieved by using a low airflow velocity to increase the residence time of air in the UV cavity and incorporating structures covered with highly reflective diffuse reflective material and located within the cavity to control the airflow and disrupt thermal effects that reduce the efficiency and effectiveness of the contaminant destruction process at low flow velocities.

In one embodiment, structures internal to the UV cavity can consist of one or more flat perforated plates covered with highly reflective diffuse reflective material. In one aspect, the open area of perforated plates located internally to the cavity can be less than 10 percent of the frontal surface area of the perforated plate.

In one aspect, the normal to the major flat surface of one or more perforated plates located internally to the cavity can be oriented at an arbitrary angle with respect to the longitudinal axis of the UV cavity.

In one aspect, one or more perforated plates located internally to the UV cavity may have a shape that is not that of a flat plate.

In one aspect, the average airflow velocity through the UV cavity can be less than 3 feet per second. In another aspect, the average airflow velocity through the UV cavity can be less than 1 foot per second.

In one aspect, a high dose required for destruction of a contaminant can be achieved by maintaining a moderate airflow velocity, but extending the length of the UV cavity and incorporating structures covered with highly reflective diffuse reflective material and located within the cavity to control the airflow and disrupt thermal effects that reduce the efficiency and effectiveness of the contaminant destruction process.

In one embodiment, structures internal to the UV cavity of extended length and moderate airflow velocity can consist of one or more vane or chevron structures covered with highly reflective diffuse reflective material and designed to direct the airflow and counteract thermal effects that reduce the efficiency and effectiveness of the contaminant destruction process.

In one embodiment, the structures internal to an extended length cavity with moderate airflow velocity can be one or more vane or chevron structures in combination with one or more perforated plates, all of which structures are covered with highly reflective diffuse reflecting material.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a schematic illustration of a UV lamp of length L.

FIG. 2 is a plot of UV power density or irradiance at a location at a distance from the UV lamp of FIG. 1, where the distance is given as multiples of lamp length L.

FIGS. 3A and 3B schematically illustrate perpendicular and parallel airflow relative to a UV lamp such as the UV lamp of FIG. 2.

FIG. 4 is a plot of flux multiplier, M, within a cavity as a function of reflectivity, R, of the cavity walls, shown for various values of the fractional absorbing or loss area, α, of the cavity walls.

FIG. 5 is a perspective view of a box structure which can be used to cover mechanical support and electrical connections for a UV or other lamp.

FIG. 6 is a perspective view of the baseline configuration of an airflow system for destruction of airborne ozone with two UV cavities in series.

FIG. 7 is a side view of the first UV cavity in the baseline configuration of FIG. 6, showing flow patterns within the UV cavity in a vertical plane located at the horizontal centerline of the cavity.

FIG. 8 is a side view of the airflow system of FIG. 6 with modifications to counteract thermal effects that reduce the performance of the system.

FIG. 9 shows flow velocities in the first UV cavity for the airflow system of FIG. 8 with the modifications shown in FIG. 8 to counteract the thermal effects that reduce system performance.

Like reference numbers and designations in the various drawings indicate like elements.

### DETAILED DESCRIPTION

Embodiments of methods and devices described herein use a reflective cavity technique that significantly increases the intensity and uniformity of ultraviolet (UV) energy, enabling very high and uniform UV irradiance. The high UV irradiance and high uniformity lead to otherwise unobtainable levels of air contaminant reduction. Embodiments are also described that provide a major increase in UV dose in flowing air by increasing the residence time of air in the UV cavity without increasing the length of the cavity.

The reflective cavity technology described herein provides a multiplication of UV irradiance by a factor of 5 to 50 times that produced by UV lamps alone. This occurs due to cavity effects, where energy is contained and intensity increases due to accumulation of reflected energy. The reflective cavity technology described herein also incorporates the use of reflective surfaces that have a diffuse or Lambertian reflective characteristic that results in highly uniform flux throughout the cavity.

UV energy density, E, is typically measured in units of microwatt-seconds/cm² (μW-s/cm²). This is a measure of the UV energy per unit area incident on the microorganism. The energy density is also referred to as the UV dose. It is the product of the instantaneous UV power density, P, and the time over which it is applied. The power density is typically measured in μWatts/cm² and is also known as UV flux or irradiance. The energy density or dose is given by:

E(μW-s/cm²)=P(μW/cm²)×t(s) (1)

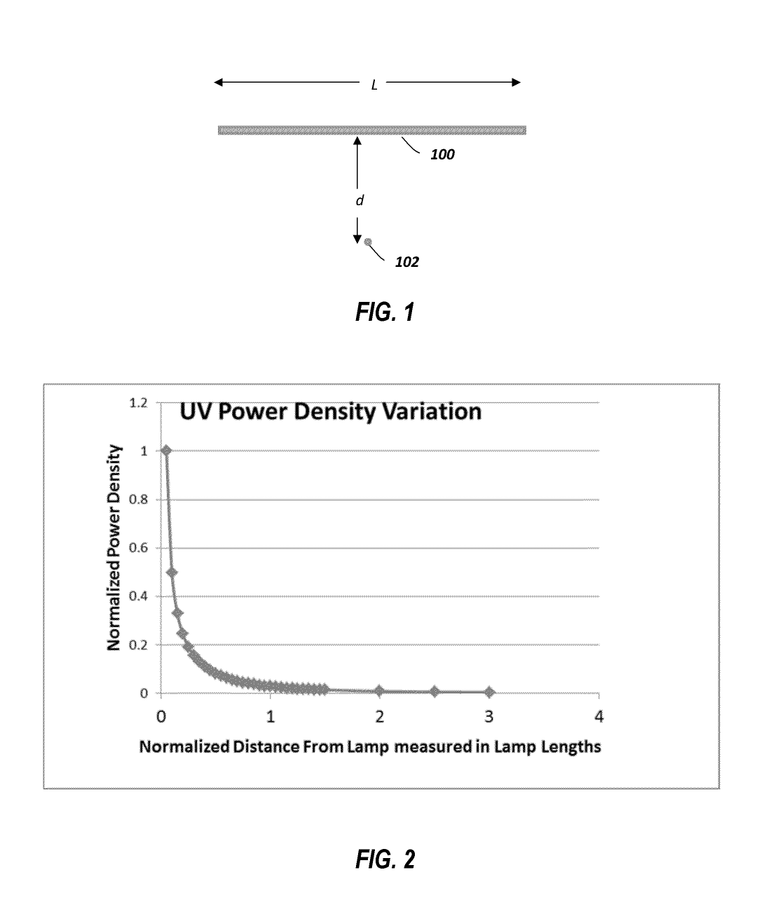

The irradiance from a UV lamp depends strongly on the distance from the lamp, decreasing rapidly as distance from the lamp increases. FIG. 1 shows a lamp 100 of length L, positioned in an air stream. In particular, FIG. 1 illustrates a geometry for calculation of UV irradiance at a point 102 located a distance d from a lamp of length L. The UV irradiance, P, measured at point 102 located a given distance d from the lamp can be calculated if the total lamp UV output power and lamp length L are known.

FIG. 2 shows a plot of the normalized power density, also known as irradiance, at the lamp axial mid-point as a function of normalized distance d from the lamp. In the plot, the distance d from the lamp is normalized as a fraction of the lamp length, L, and the UV power density is normalized to the power density at d=0.05 L. As can be seen from FIG. 2, the UV irradiance decreases very rapidly with distance from the lamp. For example, at a distance of d=0.5 L from the lamp, the UV irradiance is only about 8% of the irradiance at d=0.05 L. This creates non uniformity and regions in the air stream where the irradiance is low. If even a small fraction of the air stream is not treated effectively, the air treatment effects are significantly reduced.

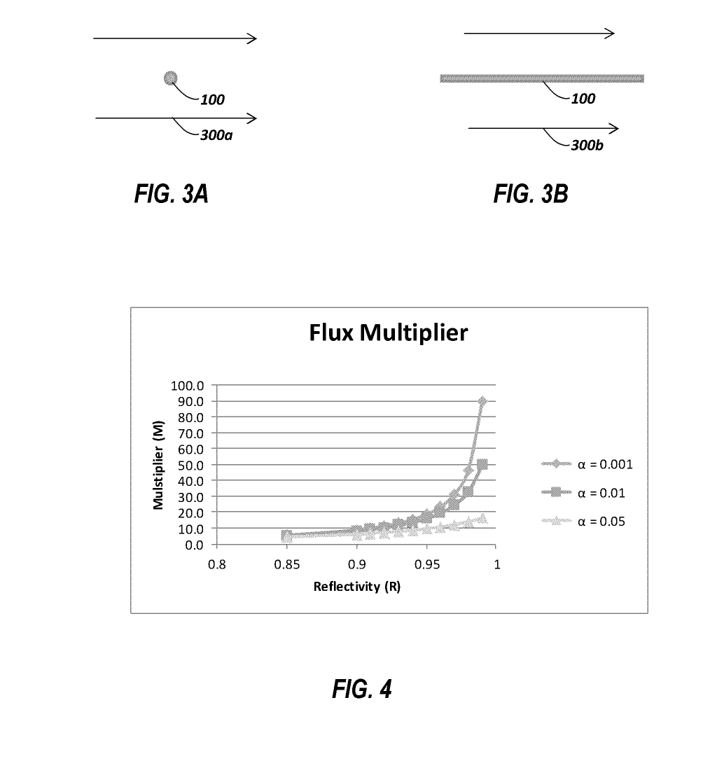

FIG. 3A is a schematic drawing showing the geometry for a cylindrical UV lamp 300a arranged with its cylindrical axis perpendicular to an airflow stream schematically illustrated as 310a. Although illustrated as discrete arrows, the lamp 300a is located within the airflow stream 310a, such that some air flows close to the lamp 300a and some air remains distant from the lamp 300a. In this arrangement, even the air which passes close to the lamp 300a spends only a very short time near the lamp 300a where the irradiance is reasonably high. As a result, the UV dose, which is the product of the irradiance and the exposure time, is low because of the short exposure time. Because the UV dose is low, airborne contaminants would not be effectively destroyed.

FIG. 3B is a schematic drawing showing the geometry for a cylindrical UV lamp 300b arranged with its cylindrical axis parallel to an airflow stream schematically illustrated as 310b. In this arrangement, as in the arrangement of FIG. 3A a large portion of the air stream is distant from the lamp 300b at locations where the irradiance is low. Even though the exposure time is increased due to the parallel positioning of the lamp 300b, the irradiance is still low because of the low irradiance of the portion of the air stream distant from the lamp, resulting in low air treatment effectiveness.

To illustrate the issue, a typical germicidal lamp 71 cm (28 inches) long producing, a total UV power of 13.5 watts, would produce an irradiance of about 8500 μW/cm² at a distance d=0.05 L=3.6 cm (1.4 inches) from the lamp. At a distance d=0.5 L=36 cm (14 inches), the irradiance would be only about 700 μW/cm². If the air is travelling at a velocity of 500 ft/min=254 cm/sec, the air in FIG. 3A would spend only a very short time near the lamp and would reach the point d=36 cm in only about 0.14 seconds. The total accumulated dose, which is determined by the product of the irradiance at each point along the trajectory and the exposure time at that irradiance, would be very low (less than about 1,000 μW-s/cm²).

The embodiments described herein provide a means of achieving highly uniform UV doses in excess of 150,000 μW-s/cm² in air. Achieving such high doses with high uniformity is not feasible with conventional UV air treatment techniques. However, embodiments described herein use a reflective cavity technique that significantly increases the intensity and uniformity of UV energy, enabling very high and uniform UV irradiance.

Conventional approaches to treating air with UV typically consist of inserting a lamp or array of lamps into an air duct, either with or without specular reflective material in the vicinity of the lamps. These “open duct” techniques do not produce a substantial increase in UV irradiance and the uniformity of the irradiance is poor. As a result of the low UV irradiance and significant variation in irradiance with position in the air stream, air treatment effects are limited.

Conventional UV systems often use specular reflectors to concentrate UV energy. Such reflectors are typically constructed of polished aluminum or chemically polished and anodized aluminum materials sold under trade names such as Alzak, Alanod, Miro, etc. These materials have specular reflective properties and typically have reflectance at UV wavelengths below 300 nm in the 80% to 90% range with some having reflectance at visible wavelengths as high as 95%. Such specular reflective materials located near a lamp or multiple lamps in an open duct provide some local focusing and concentration of UV flux, increasing in the UV flux locally, but decreasing it in other locations. They do not provide the uniform, very high flux achievable with the diffuse, high reflectivity cavity technology described herein.

The reflective cavity technology described herein provides a multiplication of UV irradiance by a factor of 5 to 50 times that produced by UV lamps alone. This occurs due to cavity effects, where energy is contained and intensity increases due to accumulation of reflected energy. The reflective cavity technology described herein also incorporates the use of reflective surfaces that have a diffuse or Lambertian reflective characteristic that results in highly uniform flux throughout the cavity.

Irradiances in excess of 75,000 μW/cm², in excess of 100,000 μW/cm², and in excess of 150,000 μW/cm² can be produced using the reflective cavity technology. Because of the uniformity that can be achieved, these irradiances may be minimum irradiance levels anywhere within a treatment chamber. Without the reflective technology 5 to 50 times as many lamps would be required to achieve these sterilization effects and the uniformity would be poor. Such a large number of lamps is not only undesirable in terms of the electrical energy that would be consumed, it is not feasible in terms of cost and the amount of physical space that would be required to install such a large number of lamps.

Uniformity is an important factor in air treatment, since regions where air is exposed to lower levels of UV can significantly degrade the overall air treatment achieved. As described above, the irradiance from a UV lamp depends strongly on distance from the lamp. As a result, in conventional UV systems, the UV irradiance varies significantly from one location in the treatment region to another. If a part of the air flowing through the treatment region is under-treated, the over-all air treatment effectiveness will be significantly decreased.

The reflective cavity technology described herein provides a solution to this problem by producing a very high level of uniformity throughout the cavity. This occurs because the cavity uses diffuse reflective surfaces to assure that UV energy reflects to every location in the cavity from every direction. The large number of reflections from all directions within the cavity add together to create a very uniform UV irradiance. UV irradiance has been measured in such cavities to be uniform within a few percent throughout the cavity, including in the center, in the corners and at the edges of the cavity. This is a unique capability of the reflective cavity technology that is not obtainable from other approaches and that is essential for achieving high contaminant destruction levels.

The reflective cavity technology involves the use of a highly reflective material having diffuse reflective properties. This material is used to line the walls of a region through which air flows, creating a highly reflective diffuse reflective cavity. The diffuse reflective material has a Lambertian reflective property as opposed to a specular reflective property. This is an important feature. For surfaces with a Lambertian reflective characteristic, UV energy incident on the surface is reflected over a broad range of angles. Surfaces that exhibit specular reflective properties reflect UV rays at an angle to the surface that is the same as that of the incident rays. This does not provide the degree of flux uniformity achievable with a Lambertian reflection characteristic.

A diffuse reflective air treatment cavity, if designed properly, is analogous to an integrating sphere, which is typically a hollow sphere with at least one small opening through which light enters. In the case of the air treatment reflective cavity, provisions must be made, of course, for entry and exit of the air into and out of the cavity. This leads to some loss of light from the cavity, but it is still possible to obtain significant increases in UV flux density within the cavity.

Integrating sphere optics equations can be used to approximate the photon flux within a highly reflective air treatment cavity. While derived for a spherical geometry, the results are based on an infinite power series of multiple reflections and give a reasonable approximation of a non-spherical geometry as long as the overall dimensions (length, width, etc.) are approximately equal.

The irradiance on the inside surface of an integrating sphere is given by the equation:

$${P}_{s} = \frac{{P}_{in}}{{A}_{s}} \times \frac{R}{1 - R ( 1 - α )} = {P}_{in} \frac{M}{{A}_{s }} , \qquad ( 2 )$$

where Pₛ is the irradiance or flux density in W/cm² near the inner surface of the sphere, R is the reflectivity of the walls, Aₛ is the total internal surface area and a is the fractional open or absorbing area of the surface. The “multiplier”, M, is a figure of merit given by:

$$M = \frac{R}{1 - R ( 1 - α )} . \qquad ( 3 )$$

This term represents an increase in irradiance due to multiple reflections. For example, the multiplier can be as large as 50 when R=0.99 and the value of a is about 0.01. Values for a for properly designed diffuse reflective cavity air treatment systems generally fall in the range of 0.01-0.05. Thus, the ratio of a sum of the open areas and interior surface area uncovered by the diffuse reflective material to the total surface area of the interior surfaces of the chamber may be between 0.01-0.05, as area uncovered by the diffuse reflective material may function similar to absorbing areas in terms of the effect on the multiplier M. Thus the UV irradiance can be increased by a factor as large as 50 in practical systems. The dependence of the multiplier on reflectivity of the chamber walls and α, as calculated from equation 3, is shown in FIG. 4.

As can be seen from FIG. 4, the irradiance or flux density multiplication factor, M, depends strongly on reflectivity of the cavity walls. The material sold by W.L. Gore under the trade name DRP has reflectivity in the UV greater than 99%. The material also has diffuse or Lambertian reflective characteristics as opposed to specular reflective characteristics. This diffuse reflective property assures a highly uniform distribution of flux density within the cavity.

An engineering model based on Equations 2 and 3 has been developed and tested and used in the design of reflective air treatment cavities to accurately predict their performance. Losses such as those due to non-reflecting or low reflectivity areas (entrance and exit areas for air and other low reflectivity or non-reflecting areas) are accounted for by means of the factor α in equation 3.

From equations 2 and 3 and FIG. 4, it can be seen that in order to avoid a significant decrease in the value of the flux multiplier, M, and a resulting degradation of the cavity performance, it is necessary to carefully control the fractional loss or absorbing area, α. The parameter α is determined by the fraction of open area at the entrance and exit to the cavity required for air flow into and out of the cavity and by the surface area of any areas located in the cavity that are not covered with highly reflective diffuse reflective material.

Plates with holes, slots or other openings can be used at each end of the cavity to allow for the entrance and exit of air while containing the UV energy. The fractional open area of these plates affect the value of the flux multiplication factor, M and the amount of pressure drop created by airflow through the cavity. The fractional open area must be selected to contain enough of the UV flux to create a significant value of the multiplier, M without creating an excessive airflow pressure drop. The airflow pressure drop associated with a perforated plate depends strongly on the fraction of open area of the plate and the velocity of the airflow. The pressure drop also depends to some extent on the shape and size of the openings, but the overall fraction of open area and the airflow velocity are more dominant parameters. Fractional ratios of open area to total plate area in the range of 0.02 to 0.4 have been generally found to be useful for most of the reflective cavity systems developed to date.

Another factor that can significantly affect the performance of the cavity is the presence of objects such as electrical connectors for the lamps, wires, ceramic end pieces on the lamps, mechanical clamps for supporting lamps, etc. Accordingly, in order to maintain a high value of the multiplier, M, and thereby improve and optimize the performance of the cavity, innovative means are desirable for supporting the lamps and providing electrical power to the lamps without introducing UV absorbing areas and materials into the cavity. If such means are not employed, the performance of the cavity and the level of UV irradiance that can be achieved will be significantly reduced.

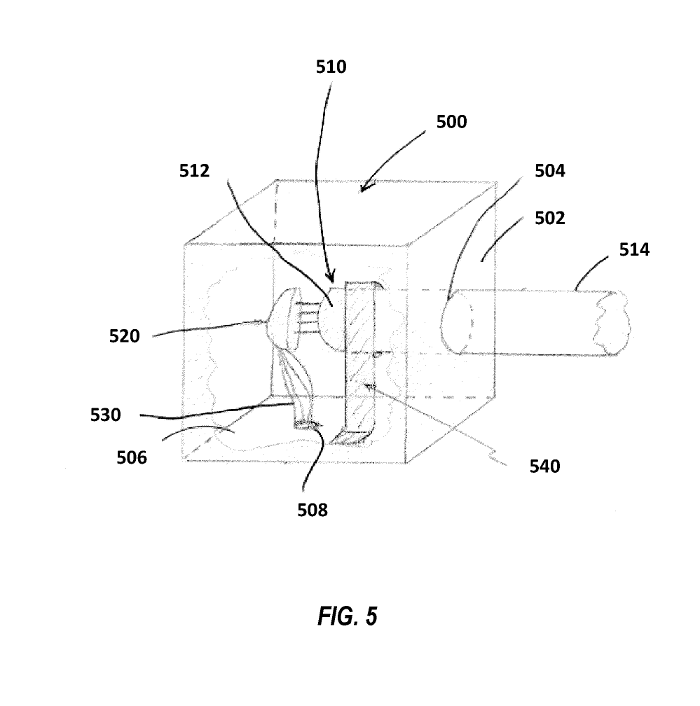

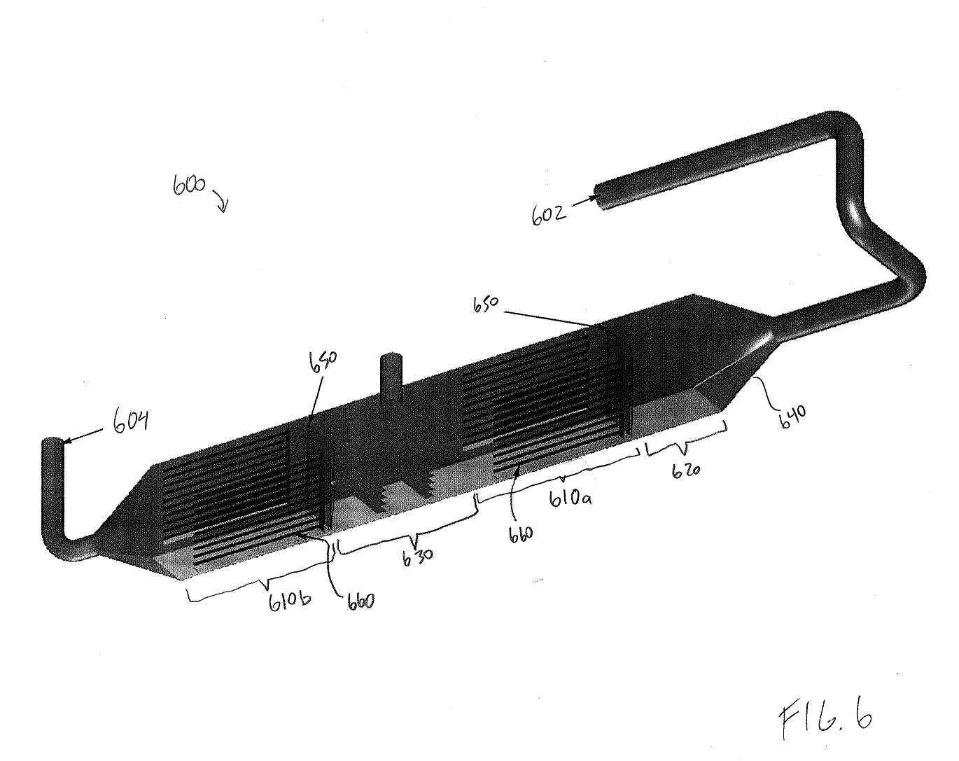

One means for minimizing UV absorbing areas in the cavity is to cover the electrical connectors and mechanical supports and mounts for the lamps with structures that are in turn covered or coated with a highly reflective diffuse reflecting material. FIG. 5 shows a perspective view of a box-like structure which encases the end portion of a lamp and the associated mechanical and electrical connections to support and provide power to the lamp.

The exposed exterior surfaces of shielding structure 500 of FIG. 5 are covered with a diffuse reflective material such as expanded PTFE. An aperture 504 formed in one of the walls 502 of shielding structure 500 allows at least the bulb portion 514 of lamp 510 to extend therethrough, while at least part of the end portion 512 of the lamp 510 is encased within the shielding structure 500. Because the end portion 512 of the lamp 510 may include a ceramic cap or similar structure which is not highly reflective, encapsulation within the shielding structure 500 will maintain a high value of the multiplier M. In addition to encapsulating the end portion 512 of lamp 510, mounting structures 540 and electrical connectors 520 and the associated wiring 530 may be encapsulated within the shielding structure 500, as well as apertures 508 formed in the side 506 of a UV treatment chamber to allow the wiring 530 to enter the chamber.

In order to achieve a high value of the multiplier, M, in equation 3 and thereby realize high values of flux, it is also important to minimize the parameter α by minimizing losses of UV energy through openings in the cavity. However, openings are necessary so that air can enter and exit the cavity. Minimizing the open area for air entry and exit minimizes the loss parameter α, but increases the air pressure drop required for a given airflow through the duct/cavity. Therefore, a compromise is required to achieve a desired value of flux in the cavity with a pressure drop for the desired airflow that is tolerable.

The UV dose delivered to a volume of air passing through a cavity depends on the UV flux in the cavity and the exposure time as described in Equation 1 above. For air flowing through a cavity, the exposure time is the time required for a volume of air to transit through the cavity. The transit time is determined by the velocity of the air stream and the length of the cavity. The velocity is determined by the volumetric airflow rate and the cross-sectional area of the cavity. These quantities are related by the following equations:

v=Q/Aₓ (4)

t=L/v=LAₓ/Q, (5)

where v is airflow velocity, Q is the volumetric airflow, L is the length of the cavity and Aₓ is the cross-sectional area of the duct/cavity perpendicular to the direction of airflow. Low velocity is desirable both to maximize exposure time and to minimize airflow pressure drop. For a given volumetric airflow requirement, Q, the velocity can be reduced by increasing the cross-sectional area, Aₓ but this increases the surface area of the cavity, which can be seen from equation 2 to cause a decrease in the UV flux, or, alternatively, a requirement for additional UV input power to maintain the desired flux level. Thus, all of these parameters must be balanced to achieve an optimum cavity design.

An important use of the UV cavity technique described above is for the destruction of airborne contaminants. One application is for the destruction of ozone in flowing air. Ultraviolet energy at the proper wavelength interacts with ozone to disassociate it into atomic and molecular oxygen. The wavelength produced by low pressure mercury lamps, approximately 254 nm, is effective for disassociation of ozone. The differential equation for the interaction rate between UV photons and the ozone molecules is:

dN(t)=N(t)σφdt, (6)

where N(t) is the number density of ozone molecules as a function of time, σ is the cross section for the interaction, φ is the photon density and t is time. This differential equation has the solution:

N(t)=N₀exp(−σφt), (7)

where N₀ is the initial ozone concentration.

This equation can be solved to give the product of photon density and time required for a desired level of ozone destruction:

(φt=−ln(N_{F}/N₀)/σ, (8)

where N_{F} is the final density of ozone remaining at the end of the destruction process.

For UV at a wavelength of 254 nm, references in the scientific literature give a value for σ of σ=1.4×10⁻¹⁷ cm².

The photon density, φ, is given by:

φ=Pᵤᵥ/hν, (9)

where Pᵤᵥ is the UV irradiance (Watts/cm²), h is Planck's constant and ν is the frequency associated with the UV wavelength. For a wavelength of 254 nm, hν=7.8×10¹⁹ Joules/photon.

For a desired level of ozone reduction, equation 8 and equation 4 give the UV energy density or dose, E, which is the product of UV irradiance and time as:

E=Pᵤᵥ×t=−(hν/σ)×ln(N_{F}/N₀)=−0.0557 ln(N_{F}/N₀). (10)

As an example, for an initial ozone level of 4.0 ppm and a final ozone level of 0.2 ppm, equation 10 gives a required dose of:

E=−0.0557×ln(0.2/4.0)=166,862μW-s/cm². (11)

The above analysis and the calculations therein provide a reasonable approximation of contaminant reduction level such as ozone when the concentration of the contaminant in air is small. However, the above calculations do not account for the decrease in UV irradiance in the diffuse reflective cavity that occurs due to the absorption of UV photons by contaminants such as ozone. When the process is applied to high concentrations of contaminants such as ozone, the amount of reduction in contaminant content is decreased significantly due to increased absorption of the UV photons by the denser contaminant. As a result, very high UV irradiance levels and long residence times are needed for effective destruction of high concentration levels of airborne contaminants such as ozone. In addition, airflow uniformity can have a major impact on the effectiveness of airborne contaminant destruction.

Absorption of a UV photon by an ozone molecule results in the removal of the absorbed UV photon, thereby reducing the UV irradiance. As a result, the linear differential equation (6) above, which assumes that the photon flux, φ, is constant, becomes a non-linear differential equation with no simple analytical solution. At high concentration levels, laboratory and pilot scale tests show significantly lower measured values of the effectiveness of UV destruction of ozone in flowing air than those calculated from the linear differential equation (6).

Destruction or Removal Efficiency (DRE), which is a parameter used to quantify ozone destruction, is defined as:

DRE (%)=(1−C₁/C₀)×100% (12)

where C₀ is the initial ozone concentration and C₁ is the concentration after exposure to the UV.

Because of absorption and removal of photons by ozone, very high irradiance levels, relatively long exposure times are required to achieve high DRE values. However, long residence times themselves can lead to heating of the air that can affect the DRE in a negative manner.

The results of tests performed in diffuse reflective cavities at high irradiance levels and long residence times illustrate effects that strongly influence achievable DRE levels. For example, pilot scale tests with a single cavity with an input ozone concentration of 165 ppm, a measured irradiance of 145,000 μW/cm², a calculated average flow velocity of 0.63 ft/sec and a calculated residence time of 10.4 seconds only gave DRE values of in the 45% to 50% range. Calculations from equation (6) for these conditions indicate that the ozone should be essentially completely destroyed, with only approximately 1 part in 2×10¹² remaining. While some of this discrepancy is undoubtedly related to photon absorption and reduction of the UV irradiance, it was also observed in tests, that the measured DRE results were very sensitive to factors related to airflow uniformity. Moreover, it was noted that the temperature of the air exiting the cavity was not spatially uniform. To understand these phenomena, computer fluid dynamics (CFD) calculations were performed to model the airflow in the cavity and calculate effects related to heating of the air by the radiated energy in the cavity. These calculations showed considerable perturbations in the airflow in the cavity as a result of heating of the air.

FIG. 6 shows a perspective representation of the baseline configuration used for the CFD calculations. Two UV cavity air treatment units 610a and 610b were located in series in an airflow system 600 with airflow at 300 cfm. The internal dimensions of each cavity were approximately 2 ft wide×4 ft high×6.5 ft long. A 3 ft long transition section 640 to allow transition from 12 inch diameter round ducting of inlet 602 to the rectangular cavity dimensions and a 4 ft long inlet 2 ft×4 ft plenum 620 preceded the first UV cavity 610a. A 6.5 ft long rectangular duct 630 connected the first UV cavity unit to the second UV cavity unit 610b. Each cavity unit had a 5% open perforated plate 650 on the inlet and outlet of the cavity to contain UV in the cavity while allowing air to enter and exit the cavity. Air passing through the airflow system then exits through outlet 604.

Each air treatment unit 610a and 610b includes UV light sources configured to emit light into the internal cavity of the air treatment units 610a and 610b. In the particular implementation illustrated in FIG. 6, the UV light source is in the form of bulb arrays 660 disposed on either side of the chamber. In one specific implementation, each chamber includes 20 bulbs total, totaling roughly 4 kW per air treatment unit. Because of the highly diffuse and highly reflective nature of the internal cavity of the air treatment units 610a and 610b, a wide range of light source configurations can alternately be used.

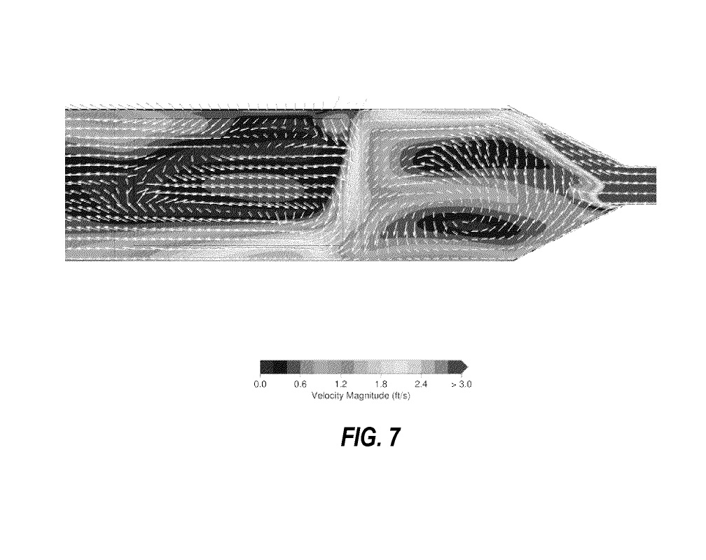

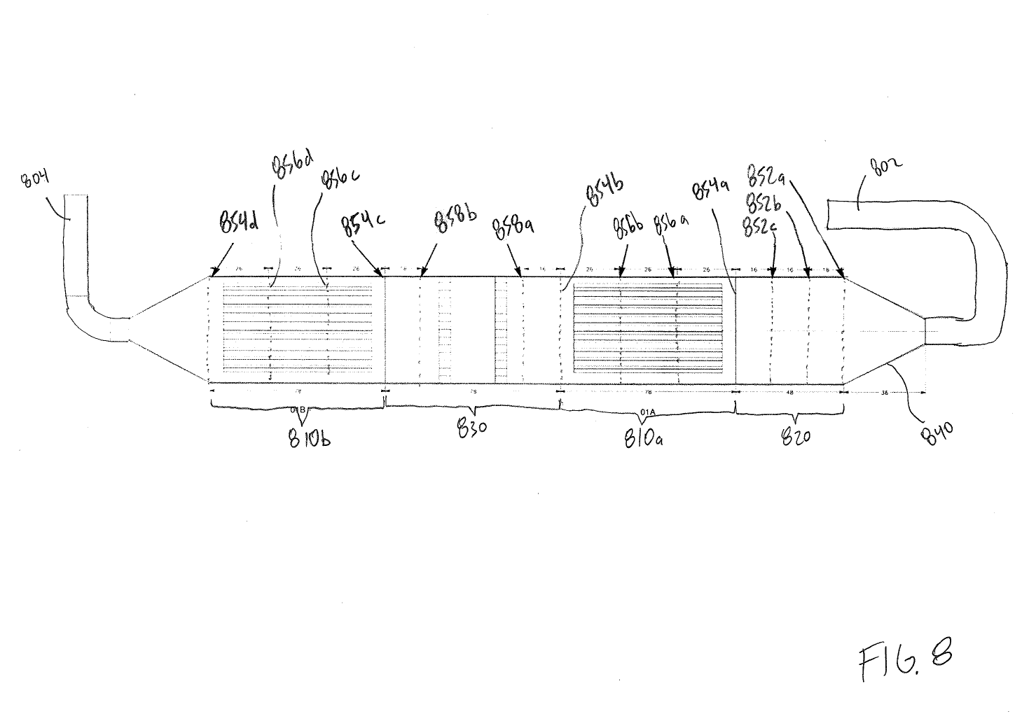

The CFD calculations for the baseline configuration of FIG. 6 showed considerable non-uniformity of flow due to thermal effects. FIG. 7 shows a representation of the airflow in the first UV cavity unit 610a in the vertical plane located at the horizontal center line for the baseline airflow system configuration of FIG. 6. The thermal effects from heating of the air by the intense UV, visible and IR radiation in the cavity result in a bubble of hot air forming near the top and center of the cavity with air circulating within the bubble and having a long residence time in the cavity. This portion of the airflow is exposed to excessive UV due to the extended residence time. Importantly, another portion of the airflow escapes at high velocity along the bottom of the cavity and is significantly under-exposed to the UV irradiance. The result is a calculated maximum residence time of 71.7 seconds, a minimum residence time of 3.75 seconds and an average residence time of 6.96 seconds in the first UV cavity. This result is consistent with the measured spatially non-uniform temperature distribution of the air exiting the cavity (very hot at top of the airstream, cool at the bottom) and the measured poor single cavity DRE test results (45%-50%) for test configurations similar to those used in the CFD calculations.

Various measures were investigated to correct the airflow uniformity problem created by heating of the airstream. CFD calculations indicated that the airflow devices such as vanes were not effective in controlling the airflow pattern by themselves. One reason for the reduced efficacy of these devices is the very low airflow velocity in the cavity which results from the need for long residence time to achieve high UV dose and practical limits on the length of the UV cavity. Because the airflow velocity is low and the kinetic energy is therefore low, some devices, which rely on using the kinetic energy of the airstream velocity to redirect the airflow, are not effective. Multiple highly restricted perforated plates can provide significant improvements in airflow uniformity, even at low airflow velocities. CFD calculations confirm that the use of multiple highly restrictive perforated plates could provide significant improvements in airflow uniformity.

FIG. 8 shows a side elevation view of a configuration of an airflow system 800 that provides a major improvement in airflow uniformity, leading to increased ozone destruction. The airflow system 800 is similar to the airflow system 600 of FIG. 6, and includes two UV cavity air treatment units 810a and 810b arranged in series, with a duct 830 connecting the UV cavity air treatment units 810a and 810b. Air enters the airflow system through inlet 804 and passes through a transition section 840 and an inlet plenum 820 before entering the first UV cavity air treatment unit 810a. Air exits the airflow system 800 through outlet 804.

As shown in FIG. 8, three perforated plates 852a, 852b, and 852c were added in the inlet plenum, two interior perforated plates 856a and 856b were added in the interior of the first UV cavity, two intermediate perforated plates 858a and 858b were added in the intermediate duct between the two units and two internal perforated plates 856c and 856d were added in the second UV cavity. The inlet perforated plates 854a and 854c and the outlet perforated plates 854b and 854d at the respective inlets and outlets of the UV cavities of the UV cavity air treatment units 810a and 810b were also retained. The perforated plates each had an open area of 3.76%.

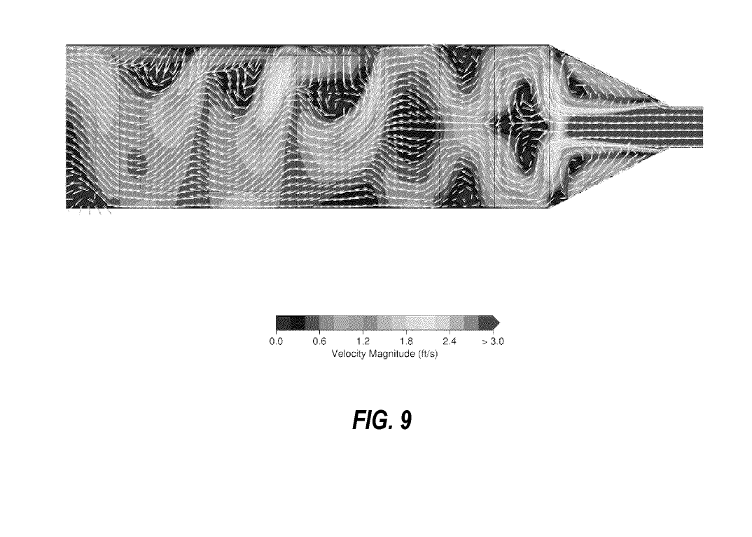

FIG. 9 shows the results of CFD calculations performed on the configuration shown in FIG. 8. The figure shows a major improvement in flow uniformity as compared to the flow pattern shown in FIG. 7 for the baseline configuration. The configuration of FIG. 9 with the multiple restrictive perforated plates gave a calculated minimum single cavity residence time of 7.88 seconds, a maximum residence time of 41.7 seconds and an average residence time of 13.82 seconds. While this is not perfect flow uniformity, it is a significant improvement over that of the baseline system.

When the design shown in FIG. 8 was tested, the single cavity DRE for ozone increased to about 75% as compared to approximately 48% for the baseline system under similar test conditions. The DRE for the design of FIG. 8 for two cavities in series was typically greater than 95%. Because the airflow velocity was low, the pressure drop for the cavities was only about 0.15 inches of water gauge per cavity. While further optimization can likely be achieved by modifying the perforated plate configurations, the use of multiple restrictive perforated plates clearly improves the performance of the UV cavities for destruction of airborne contaminants that require long residence times in the cavity to achieve high UV dose.

In some embodiments, airflow systems may include some, but not all, of the internal perforated plates described with respect to the embodiment of FIG. 8. For example, rather than including two internal perforated plates within the UV cavity air treatment units 810a and 810b, a single internal perforated plate within each UV cavity air treatment unit may be used, or three or more internal perforated plates may be used in each UV cavity air treatment unit. Similarly, any number of perforated plates may be disposed within the inlet plenum, and in some embodiments no perforated plates may be disposed within the inlet plenum. Likewise, any number of perforated plates may be disposed within the intermediate duct 830, and in some embodiments no perforated plates may be disposed within the intermediate duct 830. The relative number of internal perforated plates in each section of the may in some embodiments be adjusted independently. In some embodiments, the number of internal perforated plates within each section may be dependent upon the relative size of each section, but other factors including flow rate, temperature, and shape of the sections may also affect the number of internal perforated plates used.

In some embodiments, the perforations may be generally circular, but in other embodiments, elliptical, polygonal, or other non-circular geometric shapes may be used, and any combination of shapes can be used in a given perforated plate. In some embodiments, the perforation may be generally uniform across the perforated plates. However, in other embodiments, some or all of the perforated plates within an airflow system may include non-uniform perforation distributions. A non-uniform perforation distribution may be achieved by increasing the number of perforations at certain locations within the perforated plates, but can also be achieved by increasing the size of perforations at certain locations, or by changing the shape of the perforations at certain locations. Any combination of variance in size, number, density and shape of perforations may be used to achieve a non-uniform perforation distribution.

Such a non-uniform distribution of perforation can be used, for example, to counteract airflow patterns caused by thermal gradients within the airflow system. High temperature regions may cause air to circulate within a bubble of hot air, as discussed above, and other airflow patterns may develop. To shape airflow and minimize or disrupt undesirable airflow patterns, a non-uniform perforation distribution can alter airflow rate through the perforated plate, slowing regions of undesirable fast airflow and increasing airflow through areas in which the airflow would otherwise stagnate.

In some embodiments, the perforated plates may be disposed generally perpendicular to a central axis of the airflow system. However, in other embodiments, some or all of the perforated plates may be disposed at a different angle, so that the perforated plates are positioned at a non-right angle to the central axis of the airflow system. In some embodiments, the perforated plates may be generally planar, but in other embodiments the perforated plates may be non-flat to provide additional control over the airflow within the chamber. For example, in some embodiments, the perforated plates may have a convex or a concave shape, and other non-flat shapes can be used as well.

When physical space allows, an approach for increasing the residence time and UV dose of air in one or more UV cavities is to increase the length of the cavity or to increase the number of UV cavities in series, which essentially increases the effective UV cavity length. Increased cavity length and reduced airflow velocity can also be used in combination to increase the residence time. In these cases, when the airflow velocity is sufficient to provide enough airflow kinetic energy, other internal structures such as vanes and/or chevrons can be used to help direct airflow and disrupt the thermal disturbances that decrease the destruction of contaminants Structures such as vanes or chevrons can also be combined with perforated plates, and may be used to direct airflow and prevent airflow from by-passing the internal perforated plate structures. These vanes or other structures may be covered with highly reflective diffuse reflective material to preserve the flux multiplication properties of the UV cavity. While this approach may be desirable in some circumstances, increasing the length of the UV cavity or increasing the effective cavity length by increasing the number of cavities can add significant cost to the air treatment system.

Although the invention has been described with reference to the above examples, it will be understood that modifications and variations are encompassed within the spirit and scope of the invention. Embodiments of the UV treatment systems can be dimensioned or constructed differently than the specific embodiments depicted in the figures, and may be used in different operating conditions, or to remove other contaminants, such as absorptive contaminants other than ozone. Accordingly, the invention is limited only by the following claims.

1. An ultraviolet (UV) treatment apparatus, comprising:
a chamber, the chamber comprising a first input aperture and a first output aperture, wherein the interior surfaces of the chamber are substantially covered by a diffuse reflective material that is greater than 95% reflective to UV light;
at least one UV light source disposed within the chamber;
a first input perforated plate extending across the first input aperture of the chamber;
a first output perforated plate extending across the first output aperture of the chamber; and
at least one internal perforated plate extending across the interior of the chamber, wherein the at least one internal perforated plate is configured to increase airflow uniformity through the chamber.

2. The apparatus of claim 1, additionally comprising at least one additional internal perforated plate extending across the interior of the chamber and spaced apart from the first internal perforated plate.

3. The apparatus of claim 1, wherein each of the first input perforated plate, the first output perforated plate, and the at least one internal perforated plate extend generally parallel to one another

4. The apparatus of claim 1, wherein at least one of the first input perforated plate, the first output perforated plate, and the at least one internal perforated plate are oriented at an angle to another perforated plate

5. The apparatus of claim 1, wherein the first input perforated plate, the first output perforated plate, and the at least one internal perforated plate are generally planar.

6. The apparatus of claim 1, wherein at least one of the first input perforated plate, the first output perforated plate, and the at least one internal perforated plate is non-planar.

7. The apparatus of claim 1, wherein the internal perforated plate extends across only a portion of the interior of the chamber.

8. The apparatus of claim 7, additionally including a seal extending around the periphery of the internal perforated plate.

9. The apparatus of claim 1, wherein at least one of the first input perforated plate, the first output perforated plate, and the at least one internal perforated plate has a non-uniform distribution of perforation across its surface.

10. The apparatus of claim 9, wherein the non-uniform distribution of perforation includes a variance in the number of perforations across the surface of the perforated plate.

11. The apparatus of claim 9, wherein the non-uniform distribution of perforation includes a variance in the size of perforations across the surface of the perforated plate.

12. The apparatus of claim 9, wherein the non-uniform distribution of perforation includes a variance in the shape of perforations across the surface of the perforated plate.

13. The apparatus of claim 9, wherein the non-uniform distribution of perforation increases airflow uniformity within the chamber.

14. The apparatus of claim 1, additionally comprising:
a second chamber arranged in series with the first chamber, the second chamber comprising a second input aperture and a second output aperture, wherein the interior surfaces of the chamber are substantially covered by a diffuse reflective material that is greater than 95% reflective to UV light;
at least one UV light source disposed within the second chamber;
a second input perforated plate extending across the second input aperture of the chamber;
a second output perforated plate extending across the second output aperture of the chamber; and
at least one internal perforated plate extending across the interior of the second chamber, wherein the at least one internal perforated plate is configured to increase airflow uniformity through the second chamber.

15. The apparatus of claim 14, additionally comprising:
an intermediate duct connecting the first chamber and the second chamber, wherein the intermediate duct extends between the first output aperture of the first chamber and the second input aperture of the second chamber; and
at least one intermediate perforated plate extending across the interior of the second chamber, wherein the at least one intermediate perforated plate is configured to increase airflow uniformity through the intermediate duct.

16. The apparatus of claim 15, additionally including:
an inlet plenum disposed adjacent the first input aperture of the first chamber; and
at least one inlet perforated plate extending across the interior of the inlet plenum, wherein the at least one inlet perforated plate is configured to increase airflow uniformity through the inlet plenum.

17. The apparatus of claim 16, wherein:
at least three inlet perforated plates extend across the interior of the inlet plenum;
at least two internal perforated plates extend across the interior of the first chamber;
at least two intermediate perforated plates extend across the interior of the intermediate duct; and
at least two internal perforated plates extend across the interior of the second chamber.

18. The apparatus of claim 1, wherein the perforated plates are less than 10% open.

19. The apparatus of claim 18, wherein the perforated plates are less than 5% open

20. The apparatus of claim 1, wherein a ratio of the sum of the open area and interior surface area uncovered by the diffuse reflective material to the total surface area of the interior of the chamber walls is less than 0.05.

21. The apparatus of claim 20, wherein the ratio of the sum of the open area and interior surface area uncovered by the diffuse reflective material to the total surface area of the interior of the chamber walls is less than 0.01.

22. An ultraviolet (UV) treatment apparatus, comprising:
a chamber, the chamber comprising a first input aperture and a first output aperture, wherein the interior surfaces of the chamber are substantially covered by a diffuse reflective material that is greater than 95% reflective to UV light;
at least one UV light source disposed within the chamber;
a first input perforated plate extending across the first input aperture of the chamber;
a first output perforated plate extending across the first output aperture of the chamber; and
means for normalizing the rate of airflow within the chamber.

23. The apparatus of claim 22, wherein the normalizing means includes a perforated plate disposed within the interior of the chamber.

24. A method of reducing the presence of a contaminant in air, the method comprising:
exposing the interior of a chamber to ultraviolet (UV) light, the chamber comprising:
an input aperture,
an output aperture,
at least one internal perforated plate disposed between the input aperture and the output aperture, and
interior surfaces which are substantially covered by a diffuse reflective material that is greater than 95% reflective to UV light; and
directing air through the chamber while the chamber is being exposed to UV light, wherein exposure of the air to UV light during the passage through the chamber reduces the presence of a contaminant in the air.

25. The method of claim 24, wherein passing through the at least one internal perforated plate increases the uniformity of the airflow of air directed through the chamber.

26. The method of claim 24, wherein the amount of perforation of the at least one internal perforated plate varies across the at least one internal perforated plate.
